(19) United States
(12) Patent Application Publication
(10) Pub. No.: US 2024/0161706 A1
(43) Pub. Date: May 16, 2024

(54) DISPLAY MANAGEMENT WITH POSITION-VARYING ADAPTIVITY TO AMBIENT LIGHT AND/OR NON-DISPLAY-ORIGINATING SURFACE LIGHT

(71) Applicant: DOLBY LABORATORIES LICENSING CORPORATION, San Francisco, CA (US)

(72) Inventor: Robert Wanat, San Jose, CA (US)

(73) Assignee: DOLBY LABORATORIES LICENSING CORPORATION, San Francisco, CA (US)

(21) Appl. No.: 18/281,845

(22) PCT Filed: May 12, 2022
(86) PCT No.: PCT/US22/28928

§ 371 Date: Sep. 13, 2023

(30) Foreign Application Priority Data
May 19, 2021 (EP) 21174594.8

(51) Int. Cl. G09G 3/34; G09G 3/00

(52) U.S. Cl. CPC G09G 3/3406; G09G 3/001; G09G 2320/0238; G09G 2320/0271; G09G 2320/066; G09G 2320/0686

(57) ABSTRACT

Methods are disclosed for adaptive display management using one or more viewing environment parameters. Given the one or more viewing environment parameters, an effective luminance range for a target display, and an input image, a tone-mapped image is generated based on a tone-mapping curve, an original PQ luminance mapping function, and the effective luminance range of the display. Corrected PQ (PQ′) luminance mapping functions are generated according to the viewing environment parameters and, optionally, the transmissivity properties and reflectivity properties of the target display. PQ-to-PQ′ mappings are generated, where each corrected (PQ′) luminance mapping function is associated with a different set of viewing environment parameters and is associated with a different region of the display and where codewords in the original PQ luminance mapping function are mapped to codewords in the corrected (PQ′) luminance mapping functions, and an adjusted tone-mapped image is generated based on the PQ-to-PQ′ mappings.

### CROSS-REFERENCE TO RELATED APPLICATIONS

This application claims priority of U.S. Provisional Application No. 63/190,400 filed May 19, 2021 and European Patent Application No. 21174594.8 filed May 19, 2021, each of which is hereby incorporated by reference in its entirety.

### TECHNOLOGY

The present disclosure relates generally to images. More particularly, an embodiment of the present invention relates to adaptive display management for displaying images on displays in a viewing environment with ambient lighting and surface light not generated by the display (such as reflected or transmitted ambient light) that spatially vary across the panels.

### BACKGROUND

As used herein, the terms “display management” or “display mapping” denote the processing (e.g., tone and gamut mapping) required to map images or pictures of an input video signal of a first dynamic range (e.g., 1000 nits) to a display of a second dynamic range (e.g., 500 nits). Examples of display management processes can be found in PCT Patent Application Ser. No. PCT/US2016/013352 (to be referred to as the '352 application), filed on Jan. 14, 2016, titled “Display management for high dynamic range images;” WIPO Publication Ser. No. WO2014/130343 (to be referred to as the '343 publication), titled “Display Management for High Dynamic Range Video;” and U.S. Provisional Application Ser. No. 62/105,139, (to be referred as the '139 application), filed on Jan. 19, 2015, each of which is incorporated herein by reference in its entirety.

As used herein, the term “dynamic range” (DR) may relate to a capability of the human visual system (HVS) to perceive a range of intensity (e.g., luminance, luma) in an image, e.g., from darkest grays (darks or blacks) to brightest whites (highlights). In this sense, DR relates to a “scene-referred” intensity. DR may also relate to the ability of a display device to adequately or approximately render an intensity range of a particular breadth. In this sense, DR relates to a “display-referred” intensity. Unless a particular sense is explicitly specified to have particular significance at any point in the description herein, it should be inferred that the term may be used in either sense, e.g. interchangeably.

In a typical content creation pipeline, video is color graded in an ambient environment of 5 nits. In practice, viewers may view content in a variety of ambient environments, say, at 5 nits (e.g., watching a movie in a dark home theater), at 100-150 nits (e.g., watching a movie in a relatively bright living room), or higher (e.g., watching a movie on a tablet in a very bright room or outside, in daylight). Additionally, the ambient environments may include lighting that spatially varies across a display (e.g., non-uniform ambient lighting conditions behind a transparent display; specular reflections whose locations vary depending on relative viewer, display, and light source positions; etc.)

A reference electro-optical transfer function (EOTF) for a given display characterizes the relationship between color values (e.g., luminance) of an input video signal to output screen color values (e.g., screen luminance) produced by the display. For example, ITU Rec. ITU-R BT. 1886, “Reference electro-optical transfer function for flat panel displays used in HDTV studio production,” (March 2011), which is incorporated herein by reference in its entity, defines the reference EOTF for flat panel displays based on measured characteristics of the Cathode Ray Tube (CRT). Given a video stream, any ancillary information is typically embedded in the bit stream as metadata. As used herein, the term “metadata” relates to any auxiliary information that is transmitted as part of the coded bitstream and assists a decoder to render a decoded image. Such metadata may include, but are not limited to, color space or gamut information, reference display parameters, and auxiliary signal parameters, as those described herein.

Most consumer HDTVs range from 300 to 500 nits peak luminance with new models reaching 1000 nits (cd/m²). As the availability of HDR content grows due to advances in both capture equipment (e.g., cameras) and displays (e.g., the PRM-4200 professional reference monitor from Dolby Laboratories), HDR content may be color graded and displayed on displays that support higher dynamic ranges (e.g., from 1,000 nits to 5,000 nits or more). Such displays may be defined using alternative EOTFs that support high luminance capability (e.g., 0 to 10,000 nits). An example of such an EOTF is defined in SMPTE ST 2084:2014 “High Dynamic Range EOTF of Mastering Reference Displays,” which is incorporated herein by reference in its entirety.

As appreciated by the inventor here, improved techniques for the display of images, especially as they relate to a changing viewing environment, are desired.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section. Similarly, issues identified with respect to one or more approaches should not assume to have been recognized in any prior art on the basis of this section, unless otherwise indicated.

### BRIEF DESCRIPTION OF THE DRAWINGS

An embodiment of the present invention is illustrated by way of example, and not in way by limitation, in the figures of the accompanying drawings and in which like reference numerals refer to similar elements and in which:

FIG. 1 depicts an example process for backlight control and display management according to an embodiment of this invention;

FIG. 2 depicts an example process for display management according to an embodiment of this invention;

FIG. 3 depicts examples of ambient-light-corrected perceptual quantization curves computed according to an embodiment of this invention;

FIG. 4 depicts an example of PQ to PQ′ mapping for a given ambient light and display characteristics according to an embodiment of this invention;

FIG. 5A and FIG. 5B depict an example process for a display management process optimized for viewing conditions that spatially vary across a display according to embodiments of this invention;

FIG. 6 depicts example levels of granularity for ambient-light-adaptive display management according to an embodiment of this invention;

FIG. 7 depicts an example head-mounted display having an outward facing ambient light sensor according to an embodiment of this invention; and

FIG. 8 depicts an example transparent display having forward and rearward facing ambient light sensors according to an embodiment of this invention.

### DESCRIPTION OF EXAMPLE EMBODIMENTS

Techniques for display management or display mapping of images with position-varying ambient light adaptivity are described herein. In the following description, for the purposes of explanation, numerous specific details are set forth in order to provide a thorough understanding of the present disclosure. It will be apparent, however, that embodiments of the present invention may be practiced without these specific details. In other instances, well-known structures and devices are not described in exhaustive detail, in order to avoid unnecessarily occluding, obscuring, or obfuscating the present disclosure.

Overview

Example embodiments described herein relate to the display management of HDR and non-HDR images under changing viewing environments. As examples, changes in the ambient lighting conditions such as the locations and luminance properties of light sources, changes in displayed content and changes in the relative positions of the display device and viewers can result in viewing environments that change over time and/or that vary spatially cross the display device. Given one or more viewing environment parameters, an effective luminance dynamic range for a target display, and an input image, a tone-mapped image is generated based on a tone-mapping curve, an original PQ luminance mapping function, and the effective luminance dynamic range of the display. One or more corrected PQ (PQ′) luminance mapping functions are generated according to the viewing environment parameters and, optionally, the transmissivity properties and reflectivity properties of the target display. PQ-to-PQ′ mappings are generated, where each corrected (PQ′) luminance mapping function is associated with a different set of viewing environment parameters and is associated with a different region of the display and where codewords in the original PQ luminance mapping function are mapped to codewords in the corrected (PQ′) luminance mapping functions, and an adjusted tone-mapped image is generated based on the PQ-to-PQ′ mappings. The PQ-to-PQ′ mappings can be configured to adapt the display device to varying viewing environments by, as examples, adjusting for reflections that spatially varying across the display device and adjusting for spatially-varying ambient lighting conditions visible through a transparent display device. In the present disclosure, reflections off of a display device and ambient light that is transmitted through a transparent display device may be referred to, individually and/or collectively, as non-display originating surface light. As an example, non-display originating surface light may refer, in configurations involving a transparent display device, to both reflections off of the transparent display device and ambient light transmitted through the transparent display device. Alternatively, non-display originating surface light may refer, in some configurations involving near-eye transparent devices, to just light transmitted through the near-eye display device. In contrast, non-display originating surface light may refer, in configurations involving an opaque display device, to just reflections off of the opaque display device.

Example Display Control and Display Management

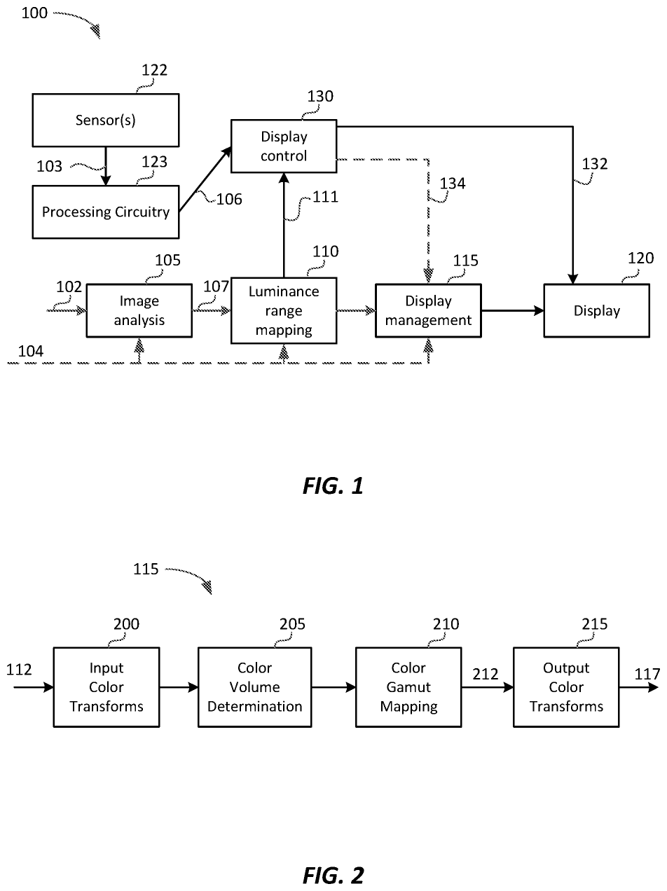

FIG. 1 depicts an example process (100) for display control and display management according to an embodiment. Input signal (102) is to be displayed on display (120). Input signal may represent a single image frame, a collection of images, or a video signal. Image signal (102) represents a desired image on some source display typically defined by a signal EOTF, such as ITU-R BT. 1886 or SMPTE ST 2084, which describes the relationship between color values (e.g., luminance) of the input video signal to output screen color values (e.g., screen luminance) produced by the target display (120). The display may be a movie projector, a television set, a monitor, and the like, or may be part of another device, such as a tablet or a smart phone.

Process (100) may be part of the functionality of a receiver or media player connected to a display (e.g., a cinema projector, a television set, a set-top box, a tablet, a smart-phone, a gaming console, a transparent display, a head-mounted display, a head-mounted transparent display, and the like), where content is consumed, or it may be integrated in the display, or it may be part of a content-creation system, where, for example, input (102) is mapped from one color grade and dynamic range to a target dynamic range suitable for a target family of displays (e.g., televisions with standard or high dynamic range, movie theater projectors, and the like).

In some embodiments, input signal (102) may also include metadata (104). These can be signal metadata, characterizing properties of the signal itself, and/or source metadata, characterizing properties of the environment used to color grade and process the input signal (e.g., source display properties, ambient light, coding metadata, and the like).

In some embodiments (e.g., during content creation), process (100) may also generate metadata which are embedded into the generated tone-mapped output signal. A target display (120) may have a different EOTF than the source display. A receiver needs to account for the EOTF differences between the source and target displays to accurate display the input image, so that it is perceived as the best match possible to the source image displayed on the source display. In an embodiment, image analysis (105) block may determine characteristics of the input signal (102), such as its minimum (min), average (mid), and peak (max) luminance values, to be used in the rest of the processing pipeline. The characteristics may, for example, be extracted from metadata, e.g., signal metadata included in metadata 104 or computed from the image signal 102. For example, given min, mid, and max luminance source data (107 or 104), image processing block (110) may compute the display parameters (e.g., the preferred backlight level(s) for display (120)) that will allow for the best possible environment for displaying the input video. Display management (115) is the process that maps the input image into the target display (120) by taking into account the two EOTFs as well as the fact that the source and target displays may have different capabilities (e.g., in terms of dynamic range, global and/or local backlight dimming, etc.)

In some embodiments, the dynamic range of the input (102) may be lower than the dynamic range of the display (120). For example, a person may desire to use a display with a maximum luminance of 1,000 nits, as part of color grading an input with a maximum luminance of 100 nits in a Rec. 709 format. In other embodiments, the dynamic range of input (102) may be the same or higher than the dynamic range of the display. For example, input (102) may be color graded at a maximum luminance of 5,000 nits while the target display (120) may have a maximum luminance of 1,500 nits.

In an embodiment, display (120) is controlled by display controller (130). Display controller (130) provides display-related data (134) to the display mapping process (115) (such as: minimum and maximum luminance of the display, color gamut information, and the like) and control data (132) for the display, such as control signals to modulate the backlight or other parameters of the display for either global or local dimming.

In an embodiment, display controller (130) may receive information (106) about the viewing environment, such as the intensity of the ambient light. This information can be derived from measurements from one or more sensors (122) attached to the device and/or from other sources such as user input, location data, default values, or other data. In some embodiments, sensor(s) (122) may produce information (103) that is processed by processing circuitry (123) to create information (106). For example, the processing circuitry (123) may receive information (103) about the viewing environment in the form of images from one or more cameras (122) and/or ambient light measurements from one or more ambient light sensors (122). As particular examples, the information (103) may include one or more color images, one or more luminance images (e.g., a grayscale image), one or more reduced-color images (e.g., images having a reduced color space), and/or one or more depth maps. Similarly, the sensor(s) (122) may include one or more full-color cameras, one or more monochrome cameras (which may be formed from a camera sensor lacking color filters), and/or one or more limited-color cameras (which may be formed from a camera sensor having at least one color filter). If desired, monochrome and reduced-color images may be generated by a full-color or reduced-color camera, by suitable processing by processing circuitry 123 or another component (e.g., by converting a full-color image into a grayscale image). As additional particular examples, the information (103) may additionally or alternatively include one or more measurements of ambient light levels from one or more ambient light sensors (122). In such examples, there may be multiple ambient light sensors (122), each of which is configured to measure the ambient light in a respective direction relative to display 120 (e.g., a first ambient light sensor may measure the amount of ambient light coming from a first direction behind the display 120, a second ambient light sensor may measure the amount of ambient light coming from a second direction behind the display 120, a third ambient light sensor may measure the amount of ambient light coming from a direction in-front of the display 120, etc., where the various directions are at least partially non-overlapping).

As another example and in addition to or in place of information from sensor(s) 122, a user could select a viewing environment from a menu, such as “Dark”, “Normal”, “Bright,” and “Very bright,” where each entry in the menu is associated with a predefined luminance value selected by the device manufacturer.

Sensor(s) 122 may include one or more sensors configured to track the position(s) of one or more viewers relative to the display (120). In some embodiments, one or more cameras may be used in tracking the position(s) of one or more viewers relative to display 120, and processing circuitry (123) may be configured to identify and/or track faces, heads, or the like of one or more viewers. In some embodiments, camera(s) used in viewer-position tracking may also be used in measuring ambient-lighting conditions. In some other embodiments, the camera(s) used in viewer-position tracking may be distinct from the camera(s) and/or other sensors used in measuring ambient-lighting conditions. In some embodiments, one or more non-camera sensor(s) may be used in tracking the position(s) of one or more viewers relative to the display (120). In general, any desired type of sensors may be used, individually or in combination, in tracking the position(s) of one or more viewers relative to the display (120) including, but not limited to, cameras, depth sensors, ultrasonic sensors, range-fingers, radar sensors, optical sensors, acoustic sensors, touch sensors, capacitive sensors, etc.

Processing circuitry (123) may process information (103) from one or more sensor(s) (122) to produce information (106) about the viewing environment, which is then usable by display control (130) as described in further detail herein. As examples, processing circuitry (123) may analyze one or more image(s) and/or video from camera(s) (122) to measure properties of the viewing environment such as, but not limited to, an average ambient light intensity, a region-by-region ambient light intensity (e.g., creation of a grayscale luminance image at a desired resolution), the position(s) of one or more viewers, the position(s) of one or more light sources, and/or the position(s) of one or more displays such as display (120). In some embodiments, processing circuitry (123) may generate estimates of screen reflections in the viewing environment. Such estimates may be derived from a model of the screen reflectivity of the display (120), measurements of the ambient light in the viewing environment (including, e.g., the distribution, position, intensity, and/or color of one or more lighting sources in the viewing environment), and measurements of the position(s) of one or more viewers relative to the display (120). Additionally or alternatively, processing circuitry (123) may generate estimates of through-display ambient light (e.g., estimates of how much ambient light passes through a transparent display before reaching a viewer, which may be done on a region-by-region basis or even a pixel-by-pixel basis).

Sensors (122) may be configured to measure the ambient environment in front of, behind, and/or to one or more sides of display (120). By measuring the ambient environment in front of the display (120), sensors (122) and processing circuitry (123) can measure the illumination on the front of the display screen (e.g., the illumination striking the front of the display screen), which is the ambient component that elevates the black level as a function of reflectivity. Similarly, by measuring the ambient environment behind the display (120), sensors (122) and processing circuitry (123) can measure the illumination behind the display screen (e.g., the illumination striking the back of the display screen). Illumination behind the display screen may also elevate the black level and otherwise impact the viewer's perception of the image, particularly when display (120) is a transparent display. For the purposes of this disclosure, the “front” of display (120) should be understood as describing the ambient environment on the same side of the display as a viewer, while “behind” display (120) should be understood as describing the ambient environment on the opposite side of the display as the viewer. Viewing environment information (106) may also be communicated to display management unit (115).

In some embodiments, the processing circuitry (123) is configured to determine ambient light levels on a pixel-by-pixel or region-by-region basis. As an example, the processing circuitry (123) may be configured to determine the relative positions of the display (120), a viewer, and at least one light source illuminating the display (120), as well as the spatial (e.g. 2D or 3D) distribution of ambient light striking the display (120). The processing circuitry (123) may utilize the collected information to determine the pixel-by-pixel or region-by-region ambient illumination as seen by the viewer. In the example of a point light source creating specular reflections off of display (120), the processing circuitry (123) may be able to determine where (in terms of specific pixel(s) and/or region(s)) on the display the specular reflections would appear to the viewer. Similarly, in the example of an ambient background with varied lighting conditions behind a transparent display, the processing circuitry (123) may be able to determine the background ambient lighting conditions on a pixel-by-pixel or region-by-region basis (e.g., determine the specific ambient lighting conditions behind each pixel, considering the viewer's perspective). A region-by-region determination is intended to describe regions of any desired size between a region of a single pixel and a region that covers the entire display. For example, a region including multiple pixels and covering only a part of the display area. The size of regions may be reconfigurable, including in real time.

In some embodiments, the transmittance and/or reflectivity of the display (120) may vary spatially and/or temporally. The variations in transmittance and/or reflectivity may be due to variations in displayed content and/or spatial variations in the design and/or construction of the display, as examples. In other words, the display (120) may be a transparent display where different regions (e.g., pixels, groups of pixels, etc.) have different levels of transmittance and/or reflectivity. Similarly, the display (120) may be an opaque display where different regions have different levels of reflectivity. As a first specific example, the display (120) may be semi-transparent or transparent and may include a first region having a transmittance of 80% and a second region having a transmittance of 85%. As noted above, the transmittance and/or reflectivity of the display (120) may vary based on displayed content, and thus the transmittance and/or reflectivity may vary temporally as the displayed content is changed (and spatially, as the displayed content may vary spatially). The techniques disclosed herein for determining and adjusting for ambient light levels on a pixel-by-pixel or region-by-region basis may consider the spatially varying and/or temporally varying transmittance and/or reflectivity of the display (120). As an example, measured values for ambient light (measured by a sensor that does not look through the display (120)) may be decreased based on the region-by-region transmittance properties of the display (120). As another example, measurements and predictions of reflections off of the display (120) may be adjusted based on region-by-region reflectivity properties of the display (120). PQ-to-PQ′ mappings associated with lower levels of ambient light may be utilized for regions where the transmittance and/or reflectivity of the display (120) is lower (due to spatial and/or temporal variations). Conversely, PQ-to-PQ′ mappings associated with higher levels of ambient light may be utilized for regions where the transmittance and/or reflectivity of the display (120) is higher. In embodiments in which transmittance and/or reflectivity of the display (120) varies based on displayed content, a displayed image (e.g., the displayed content) may be used as an input to determine the spatial distribution of the current transmittance and/or reflectivity of the display (120) (e.g., the transmittance and/or reflectivity while displaying said image).

Displays using global or local backlight modulation techniques adjust the backlight based on information from input frames of the image content and/or information received by local ambient light sensors. For example, for relatively dark images, the display controller (130) may dim the backlight of the display to enhance the blacks. Similarly, for relatively bright images, the display controller may increase the backlight of the display to enhance the highlights of the image, as well as elevate the dark region luminance since it would fall below threshold contrasts for a high ambient environment. Local backlight modulation techniques may involve adjusting the backlight at any desired level of granularity, such as pixel-by-pixel or region-by-region, and the regions need not be uniform in size and/or shape. As an example, a head-mounted display may be divided into local backlight regions of unequal size, with areas corresponding to the center of the viewer's perspective having relatively small regions with independent backlight control and areas corresponding to the periphery of the viewer's perspective having relatively large regions with independent backlight control (since viewers are typically less focused on peripheral content).

As described in WO2014/130343, and depicted in FIG. 2, given an input (112), the display characteristics of a target display (120), and metadata (104), the display management process (115) may be sub-divided into the following main steps:
a) Step (200)—Optional input color conversions, e.g., from RGB or YCbCr to IPT-PQ
b) Step (205)—Determining the color volume for the target display, including tone mapping and saturation adjustments
c) Step (210)—Performing the color gamut mapping (CGM) for the target display
d) Step (215)—Output color transforms (e.g., from IPT-PQ to whatever color format is needed for the target display or other post-processing)

As used herein, the term “color volume space” denotes the 3D volume of colors that can be represented in a video signal and/or can be represented in display. Thus, a color volume space characterizes both luminance and color/chroma characteristics. For example, a first color volume “A” may be characterized by: 400 nits of peak luminance, 0.4 nits of minimum luminance, and Rec. 709 color primaries. Similarly, a second color volume “B” may be characterized by: 4,000 nits of peak luminance, 0.1 nits of minimum luminance, and Rec. 709 primaries.

In an embodiment, as noted earlier, color volume determination (205) may include the following steps:
a) applying a tone mapping curve to remap the intensity channel (I) of the input video according to the display characteristics of the target display, and
b) applying a saturation adjustment to the tone-curve mapping step to account for the adjustments in the intensity channel. The saturation adjustment may be dependent on the luminance level of the pixel or its surrounding region.

The initial color volume determination (205) may result in colors outside of the target display gamut. During color gamut mapping (210), a 3D color gamut look-up table (LUT) may be computed and applied to adjust the color gamut so that out of gamut pixels are brought inside or closer to the color volume of the target display. In some embodiments, an optional color transformation step (215) may also be used to translate the output of CGM (212) (e.g. RGB) to a color representation suitable for display or additional processing (e.g. YCbCr), according to the display's EOTF.

As mentioned earlier, in an embodiment, color volume determination may be performed in the IPT-PQ color space. The term “PQ” as used herein refers to perceptual quantization. The human visual system responds to increasing light levels in a very non-linear way. A human's ability to see a stimulus is affected by the luminance of that stimulus, the size of the stimulus, the spatial frequency(ies) making up the stimulus, and the luminance level that the eyes have adapted to at the particular moment one is viewing the stimulus. In an embodiment, a perceptual quantizer function maps linear input gray levels to output gray levels that better match the contrast sensitivity thresholds in the human visual system than traditional gamma functions. An example of a PQ mapping function is described in the SMPTE ST 2084 specification, where given a fixed stimulus size, for every luminance level (i.e., the stimulus level), a minimum visible contrast step at that luminance level is selected according to the most sensitive adaptation level and the most sensitive spatial frequency (according to HVS Contrast Sensitivity Function (CSF) models, which are analogous to spatial MTFs). Compared to the traditional gamma curve, which represents the response curve of a physical cathode ray tube (CRT) device and coincidentally may have a very rough similarity to the way the human visual system responds but only for limited dynamic ranges of less than 2 log 10 units, a PQ curve imitates the true visual response of the human visual system using a relatively simple functional model. Further, it more accurate over a much larger dynamic range.

The IPT-PQ color space, as also described in the '343 publication, combines a PQ mapping with the IPT color space as described in “Development and testing of a color space (ipt) with improved hue uniformity,” Proc. 6^{th} Color Imaging Conference: Color Science, Systems, and Applications, IS&T, Scottsdale, Arizona, November 1998, pp. 8-13, by F. Ebner and M. D. Fairchild, which is incorporated herein by reference in its entirety. IPT is like the YCbCr or CIE-Lab color spaces; however, it has been shown in some scientific studies to better mimic human visual processing than these other color spaces, because the I is a better model of spatial vision than the Y, or L* used in these other models. An example of such a study is the work by J. Froehlich et al. “Encoding color difference signals for high dynamic range and wide gamut imagery,” Color and Imaging Conference, Vol. 2015, No. 1, October 2015, pp. 240-247(8), Society for Image Science and Technology.

The display management process (115), which typically does not use signal 106, works well under the assumption of a reference dim viewing environment. Since many viewers watch content in a non-reference viewing environment, as appreciated by the inventors, it would be desirable to adjust the display management process according to changes in the viewing conditions.

In an embodiment, two additional steps may be incorporated to the steps described earlier:
a) during color volume determination (205), applying one or more tone mapping curves to remap the intensity channel to account for the difference between a reference dark viewing environment and the actual viewing environment, with each applied tone mapping curve being associated with different viewing conditions and being applied to respective screen positions or regions; and
b) before the output color transformations (215), taking into consideration and subtracting the estimated reflected light from the display and, for transparent displays, the estimated ambient light transmitted through the display.
   Each of these steps is discussed in more detail next.

Position-Dependent Ambient-Light-Corrected Perceptual Quantization

The PQ mapping function adopted in the SMPTE ST 2084 specification is based on work done by J. S. Miller et al., as presented in U.S. Pat. No. 9,077,994, “Device and method of improving the perceptual luminance nonlinearity-based image data exchange across different display capabilities,” which is incorporated herein by reference in its entirety. That mapping function was derived for a viewing environment with minimal ambient surround light, such as a completely dark room. Hence, it is desirable to compute alternative PQ mapping functions, to be referred to as PQ′, by taking into consideration the viewing conditions, and in particular, the intensity of the ambient light and reflections off of the display, which can vary from one position on the screen to another and/or as a viewer's relative position to a display changes. For example, taking into consideration the ambient light ensures that details in the dark areas of the image are not perceived as uniformly black when the scene is viewed in a brighter environment. Following the same approach as Miller et al., the steps of a PQ′ mapping may be derived iteratively. In an embodiment, for Lₒ at about 10⁻⁶ nits,

$${L}_{k + 1} = {L}_{k} * ( \frac{1 + 0.9 * {m}_{t}}{1 - 0.9 * {m}_{t}} ) , \qquad ( 1 )$$

where Lₖ denotes the k-th step and mₜ denotes a detection threshold, which is the lowest increase of luminance an average human can detect at luminance Lₖ. Multiplying mₜ by 0.9 ensures the increment will not be visible. In an embodiment, mₜ is determined as a function of a contrast sensitivity function (S(L)) at the spatial frequency where the sensitivity is the highest for luminance L and an ambient-light factor (A(Lₐ)) at ambient (surround) luminance Lₐ, as

$${m}_{t} ( L , {L}_{a} ) = \frac{1}{S ( L ) * A ( {L}_{a} )} . \qquad ( 2 )$$

Without limitation, examples of S(L) and A(Lₐ) functions are presented by P. G. J. Barten, “Formula for the contrast sensitivity of the human eye,” in Image quality and system performance, edited by Y. Miyake and D. R. Rasmussen, Proc. Of SPIE-IS&T Electronic Imaging, SPIE Vol. 5294, 2004, pp. 231-238, (e.g., see equations 11 and 13), which is incorporated herein by reference in its entirety.

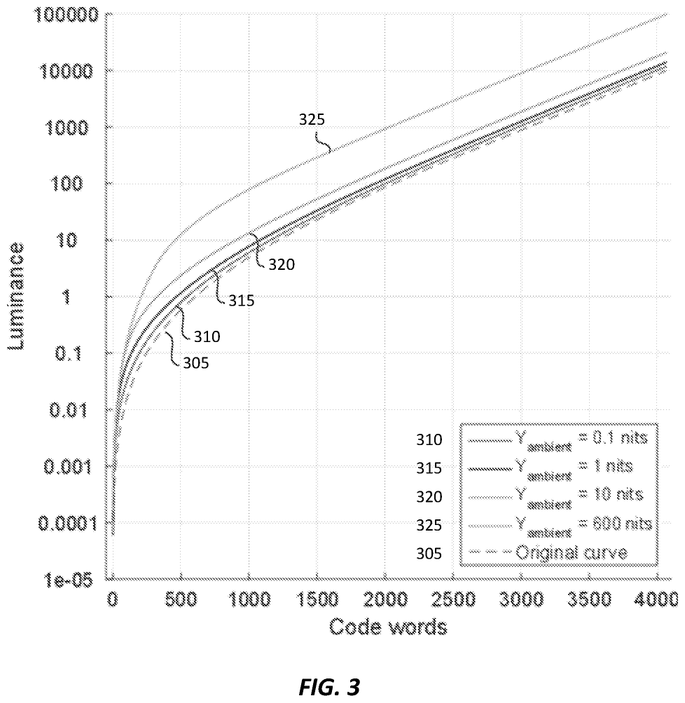

Examples of PQ′ curves (310, 315, 320, 325) computed at various levels of ambient light ranging from 0.1 to 600 nits, for a 12-bit input, are shown in FIG. 3. The original PQ curve (305) is also depicted. The ambient-light-corrected curves generally require a higher dynamic range to offer the same number of distinct code words as the original PQ curve.

PQ to PQ′ Mapping Adjustment

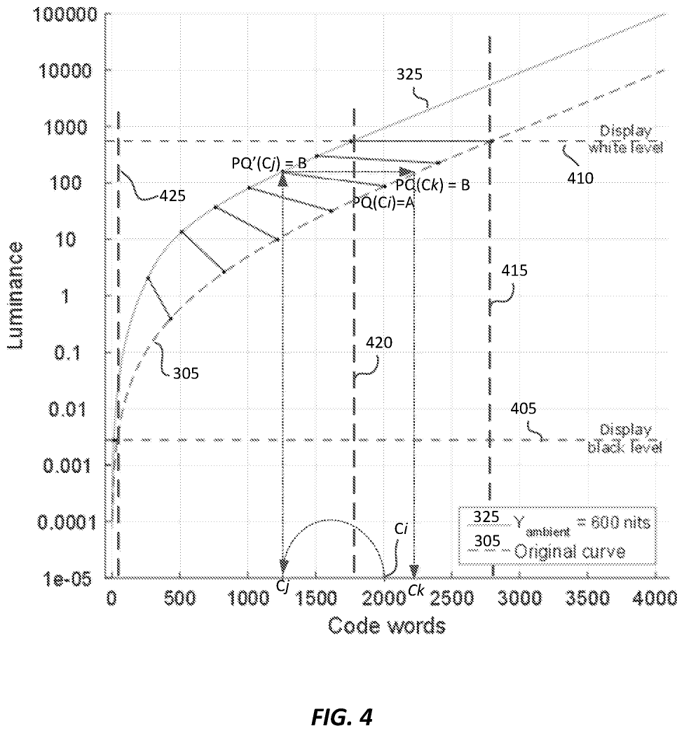

As discussed earlier, in an embodiment, the display management process (115) is performed in the IPT-PQ domain. Incoming signals in other domains (e.g., RGB in BT1866), before any processing, are de-linearized and converted to IPT-PQ (e.g., in 200). Then, as part of color volume determination (e.g., in 205), the intensity component of the input (e.g. Iₘ) is remapped to new intensity values (e.g. font) according to the characteristics of the target display, such as, its minimum and maximum luminance (405 and 410). The input color transformation (e.g. from RGB to IPT) assumes an original PQ curve (305) computed under the assumption of a dark environment. As an example, FIG. 4 depicts the original PQ curve for 12 bits. It also depicts the minimum and maximum luminance levels of a target display, to be denoted as TMin (405) and TMax (410).

As can be seen in FIG. 4, given TMin and TMax, only a part of the available code words will be used, from CMin (425) to CMax (415), where PQ(CMin)=TMin and PQ(CMax)=TMax. The goal of a PQ to PQ′ mapping adjustment is to map incoming intensity (I) values to new intensity values (I′) by taking into consideration both the luminance characteristics of the target display and the localized ambient light conditions (e.g., the ambient light conditions associated with a particular region or pixel of the display and, where appropriate such as for reflections, considering the relative positions of the display and one or more viewers).

Consider now, as an example, an ambient light raising luminances for a given pixel, set of pixels, region, or the like measured, without limitation, at La nits (e.g., La=600). The ambient light raising luminances for a given pixel, set of pixels, region, or the like may include a combination of diffuse ambient light falling on the display; specular reflections that appear to the viewer at the position of the given pixel, set of pixels, region, or the like; and/or ambient light transmitted through a transparent display and that appear to the viewer at the position of the given pixel, set of pixels, region, or the like. As depicted in FIG. 4, the PQ′_{La} mapping function (325) for La=600 nits, representing the ambient-light-adjusted PQ mapping, typically allows a different number of code words to be used, say from CMin′ (not shown for clarity) to CMax′ (420), where PQ′_{La}(CMin′)=TMin and PQ′_{La}(CMax′)=TMax. In general, the particular PQ′ mapping function that is selected and utilized is selected based on the luminance combination of diffuse ambient light and non-display originating surface light (e.g., the PQ′ mapping function that is closest to the luminance combination may be selected an utilized). As an example, the PQ′_{La} mapping function (325) for Lₐ=600 nits may be applied to a given pixel (or set of pixels, region, or the like) when the luminance combination of diffuse ambient light, specular reflections at the position of the given pixel, and ambient light transmitted through a transparent display at the position of the given pixel is equal to 600 nits. In some embodiments, specular reflections may not be considered in the luminance combination, the display may be opaque and thus ambient light transmitted through a transparent display may not be considered in the luminance combination, and/or diffuse ambient light may not be considered in the luminance combination.

In an embodiment, to preserve the appearance of the original image viewed at a different ambient light, the first step in the PQ to PQ′ mapping is to map values of the original curve (say, PQ(Ci), for Ci=CMin to CMax) to corresponding values in the adjusted curve (say, PQ′_{La}(Cj), for C=CMin′ to CMax′). As an example, as depicted in FIG. 4, at about Ci=2,000, PQ(Ci)=A is mapped to PQ′_{La}(Cj)=B. In an embodiment, this mapping is performed by preserving image contrast, as measured in units of just-noticeable-differences (JNDs), in terms of the position of the original intensity value relative to the total number of PQ steps offered by the display. That is, if a codeword (Ci) lies at e.g. 1/n of the full PQ range (CMin to CMax), the corresponding codeword (Cj) in PQ′ should also lie at 1/n of the full PQ′ range (CMin′ to CMax′). Assuming, with no limitation, a linear interpolation mapping, this can be expressed as:

$$\frac{CMax - Ci}{CMax - CMin} = \frac{{CMax}^{′} - Cj}{{CMax}^{′} - {CMin}^{′}} , \qquad ( 3 )$$

$$or Cj = ⌊ {CMax}^{′} - ( {CMax}^{′} - {CMin}^{′} ) * \frac{CMax - Ci}{CMax - CMin} ⌋ .$$

This provides a similar proportional placement of the code values in each of the ranges resulting from the different ambient conditions. In other embodiments, other linear or non-linear mappings may also be employed.

For example, given approximate values extracted from FIG. 4, say CMax=2850, CMin=62, CMax′=1800, and CMin′=40, for Ci=2000, from equation (3), Cj=1263. In summary, given an input codeword I=Ci mapped according to PQ(Ci), its luminance should be adjusted to correspond to the same luminance as mapped for PQ′_{La}(Cj).

Given now the PQ′_{La}(Cj) values, using the original PQ curve, one can identify the codeword Ck in the input stream for which PQ(Ck)=PQ′_{La}(Cj). In other words:
if PQ(Ci) is mapped to PQ′_{La}(Cj)

then codeword Ci is mapped to codeword Ck so that PQ(Ck)=PQ′_{La}(Cj). (4)

Hence, each original PQ codeword Ci, for Ci in CMin to CMax, may be mapped to its corresponding PQ codeword Ck. In other words, given input pixel Iₙ, its remapped output Iₙ′ due to ambient light adjustments will be:

if (Iₙ==Ci) then Iₙ′=Ck. (5)

In some embodiments, the input may be expressed as a normalized value in (0,1). Then if the PQ and PQ′ curves are computed for B bits of precision, equation (5) can be expressed as

$$if ( {I}_{n} == \frac{Ci}{{2}^{B} - 1} ) then {I}_{n}^{′} = \frac{Ck}{{2}^{B} - 1} . \qquad ( 6 )$$

The proposed mapping allows the remapped intensity data (e.g., Iₙ′) to be displayed on the particular region(s) and/or pixel(s) of the target display at the adjusted luminance which is best suited for the viewing environment localized to the particular region(s) and/or pixel(s). In other words, different mappings (e.g., different PQ to PQ′ mappings, each involving a different PQ′ curve, such as a different one of the illustrative curves 310, 315, 320, and 325 of FIG. 3) may be used to remap intensity data for different region(s) and/or pixel(s) of the target display, depending on the viewing environment conditions localized to those region(s) and/or pixel(s).

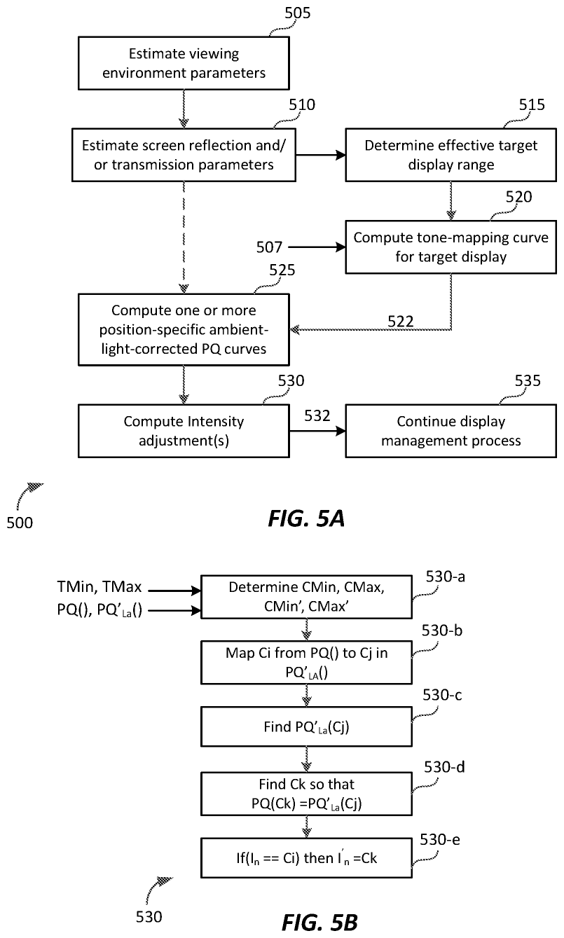

FIG. 5A depicts an example process for performing ambient-light-corrected display management according to an embodiment. As depicted in FIG. 5A, steps 515, 520 and 535 represent the traditional display management process, for example, as discussed in the '343 publication and/or the '139 application. The remaining steps represent additional representative steps for a display management process that can be adapted for specific viewing environments that may vary across the display.

In some embodiments, the tone mapping curve is applied only to the luminance intensity channel (I) because the ambient model predicts perception changes in the luminance domain only. An accurate prediction of these changes requires the information about the absolute luminance levels of the displayed image, so the processing should preferably be conducted in a color space that facilitates an easy conversion to linear luminance, which the RGB space does not. The method does not explicitly process chrominance, it is instead assumed that the saturation mapping step (e.g., as performed after tone-mapping) can accurately predict the change in saturation caused by the luminance change during the PQ to PQ′ mapping and compensate for it.

In step 505, the process estimates viewing environment parameters. In some embodiments, viewing environment parameters are estimated or otherwise received or determined according to user input. In some other embodiments, viewing environment parameters are estimated or otherwise received or determined according to sensor input reflecting the actual viewing environment. For example, any of the known methods in the art can be used to provide an estimate of the surrounding ambient light including luminance, hue, chromacity, etc. In some embodiments, the estimate of the surrounding ambient light can include spatial variations in the ambient light. As an example, the estimate of the surrounding ambient light can include a plurality of estimates, each being associated with a different spatial region of the actual viewing environment. Optionally, in step 510, the process may also take into consideration screen reflections and/or ambient light transmitted through a transparent display. For example, a measure of screen reflections may be estimated based on a model of the screen reflectivity of the display and the viewing parameters of step 505. Similarly, a measure of ambient light transmitted through a transparent display may be estimated based on a model of the screen transmissivity of the display and the viewing parameters of step 505. In some embodiments, step 505 may include estimating screen reflections and/or ambient light transmitted through a transparent display at multiple positions across the display.

A key component of display management is determining the luminance characteristics of the target display (e.g., minimum, medium or average, and maximum luminance). In some embodiments, these parameters are fixed, but in some other embodiments (e.g., with displays supporting a dynamic backlight), they may be adjusted according to the luminance characteristics of the input video and/or the viewing environment. In an embodiment, the effective range of a target display may be adjusted according to the screen reflection measure computed in step 510. For example, if the target display range is 0.005 nits to 600 nits in a dark environment, and the screen reflections are estimated at 0.1 nits, then the effective display range could be defined to be 0.105 to 600.1 nits. More generally, given an effective dynamic range for a target display (e.g., TMin and TMax), and given a measure Lr of the screen reflectivity, one may adjust the effective display range to be

TMin′=TMin+Lr,

TMax′=TMax+Lr. (7)

Then CMin′ and CMax′ may be determined so that TMin′=PQ′(CMin′) and TMax′=PQ′(CMax′).

In step 520, as described in the '343 publication and/or the '139 application, the dynamic range of an input image (507) is mapped to the target display range using a tone mapping curve. This step assumes a default PQ curve (e.g., as defined in ST 2084), computed for a nearly dark environment. Its output will be intensity samples (In) in a tone-mapped image (522).

Given a measure of ambient light (La), as determined in step 505, in step 525 one or more new ambient-light-corrected PQ curves (one or more PQ′_{La}) are computed, for example using equations (1-2), with each PQ′ curve being associated with a different set of viewing conditions (as such viewing conditions may vary spatially across the display). Given PQ, one or more PQ′_{La}, and the output of the tone-mapping step (520), step 530 computes new intensity values Iₙ′ as described in equations (3-6). These steps, as described earlier and also depicted in FIG. 5B, include:
For each region or pixel of the display, determine CMin, CMax, CMin′, and CMax′ based on (TMin, TMax) or (TMin′, TMax′), and the PQ functions PQ(and PQ′_{La}) (Step 530-a), where the PQ function PQ′_{La}( ) is selected according to the viewing conditions for the respective region or pixel (e.g., the combination of diffuse ambient light and/or non-originating surface light at the respective region or pixel).
For each region or pixel of the display, map each input codeword Ci in PQ(to a codeword C in the appropriate PQ′_{La}( ) according to a mapping criterion, e.g., to preserve image contrast according to equation (3) (Step 530-b)
For each region or pixel of the display, determine PQ′_{La}(Cj)=B (Step 530-c)
For each region or pixel of the display, determine a new codeword Ck such that PQ(Ck)=PQ′_{La}(Cj)=B (Step 530-d)
For each region or pixel of the display, if (Iₙ==Ci) then Iₙ′=Ck (Step 530-e)

In some embodiments, the selection or computation of an ambient-light-corrected PQ curve for a given region or pixel in step 525 may involve determining which of a plurality of ambient-light-corrected PQ curves, out of a plurality of ambient-light-corrected PQ curves, is associated with the level of ambient light and/or non-display originating surface light that most closely matches (as compared to the other ambient-light-corrected PQ curves in that plurality) the viewing conditions for the given region or pixel.

Given the new intensity values for a corrected tone-mapped image (532), the display management process (500) may continue as described in in the '343 publication and/or the '139 application, with such steps as: saturation adjustment (where the P and T components of the input signal are suitable adjusted), color gamut mapping (210), and color transformations (215).

If screen reflectivity (Lr) was taken into consideration for the Ci to Ck codeword mapping, then in an embodiment, before displaying the image onto the target display, one should subtract the estimated screen reflectivity for the relevant region(s) and/or pixel(s), otherwise the actual screen reflectivity will be added twice (first by equation (7), and second by the actual light on the display). This can be expressed as follows:
Let, (e.g., after color gamut mapping (210)), under reflective light adjustment Lr, codeword Cm to be mapped to PQ(Cm); then
   Find codeword Cn such that PQ(Cn)=PQ(Cm)−Lr
if (Iₒ==Cm) then Iₒ′=Cn, where Iₒ denotes the output (212) of color gamut mapping and Iₒ′ the adjusted output for screen reflectivity Lr under ambient light La.

The ambient light corrected curves can be calculated using the steps described previously, or they can be calculated as one or more 2D LUTs, each with inputs being ambient light (505) and the original tone mapping curve (522). Alternately, functional approximation of the ambient correction curves may be used, for example cubic Hermite splines or polynomial approximations. Alternately, the parameters controlling the original curve can be modified to simultaneously perform the original tone mapping (507) and ambient corrected tone mapping (525) in a single step. In some embodiments, the ambient environment for generating the source image may also be known, in which case, one may perform a first set of PQ to PQ′ mappings for the source image and source viewing environment, then a second set of PQ to PQ′ mappings for the target image and target viewing environment, where at least one of the first and second sets of PQ to PQ′ mappings involves applying different PQ to PQ′ mappings to different regions and/or pixels of the display depending on spatially-varying viewing environment conditions.

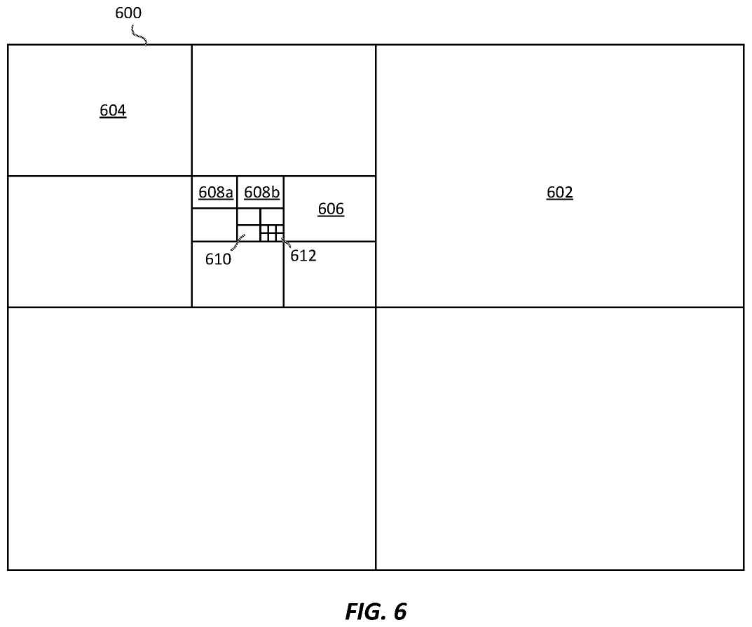

As discussed earlier, viewing environment conditions may vary across a display. As examples, a specular reflection may be present only across a first region of the display and a background behind a transparent display may have varying lighting conditions. It may therefore be desirable to apply different ambient correction curves (such as the example ambient correction curve shown in FIG. 4) to different regions or pixels of the display. As shown in FIG. 6, a display 600 may be divided into regions of any desired size down to the individual pixel level. As examples, display 600 may be dived into quarters 602 or into smaller regions such as regions 604, 606, 608a, 608b, and 610. In accordance with the present disclosure, adapting the display for the viewing environment conditions may including applying a first ambient correction curve associated with a first level of ambient luminance to one or more first regions associated with the first level of ambient luminance, applying a second ambient correction curve associated with a second level of ambient luminance to one or more second regions associated with the second level of ambient luminance, and so on. In the extreme, a unique ambient correction curve could be applied to each pixel of the display.

In at least some embodiments, it may be desirable to constrain the spatial rate of change in applied ambient correction curves across a display. Considerer, as a specific example, an example in which the ambient luminance level for region 608a is only 1 nit, is 600 nits for the immediately adjacent region 608b. In embodiments that do not constrain the spatial rate of change in applied ambient correction curves across a display, a PQ to PQ′ mapping involving PQ′ curve 315 could be applied to region 608a, while a PQ to PQ′ mapping involving PQ′ curve 325 could be applied to region 608b. However, using PQ′ curves 315 and 325 in adjacent regions might degrade the user's viewing experience. Thus, it may be desirable to constrain the spatial rate of change in applied ambient correction curves across a display.

One technique to constrain the spatial rate of change in applied ambient correction curves involves smooth or stepped transitions between adjacent regions with different ambient correction curves. As an example, PQ′ curves 315 and 325 could be applied to regions 608a and 608b, respectively, but some fraction (e.g., 5%, 10%, 15%, 20%, etc.) of the right portion of region 608a and/or of the left portion of 608b may be adjusted with an ambient correction curve somewhere between PQ′ curves 315 and 325, such that there is an overall smooth or stepped transition.

Another technique for constraining the spatial rate of change in applied ambient correction curves involves prohibiting rapid changes in applied PQ′ curve. As an example, a display management system may be configured to block application of PQ′ curve 315 to a region 608a and application of PQ′ curve 325 to region 608b, because curves 315 and 325 and too similar in combination with the close proximity of region 608a and 608b. In such an example, the display management system may instead apply PQ′ curve 320 to one or more of regions 608a and 608b, such that the immediately adjacent regions are associated with either identical PQ′ curves or PQ′ curves that are relatively similar. Similarity between PQ′ curves may be measured in terms of steps (the next available PQ′ curve), associated ambient luminance level, percent change in luminance for a given code word, or any other suitable measure.

Example Display System Implementations

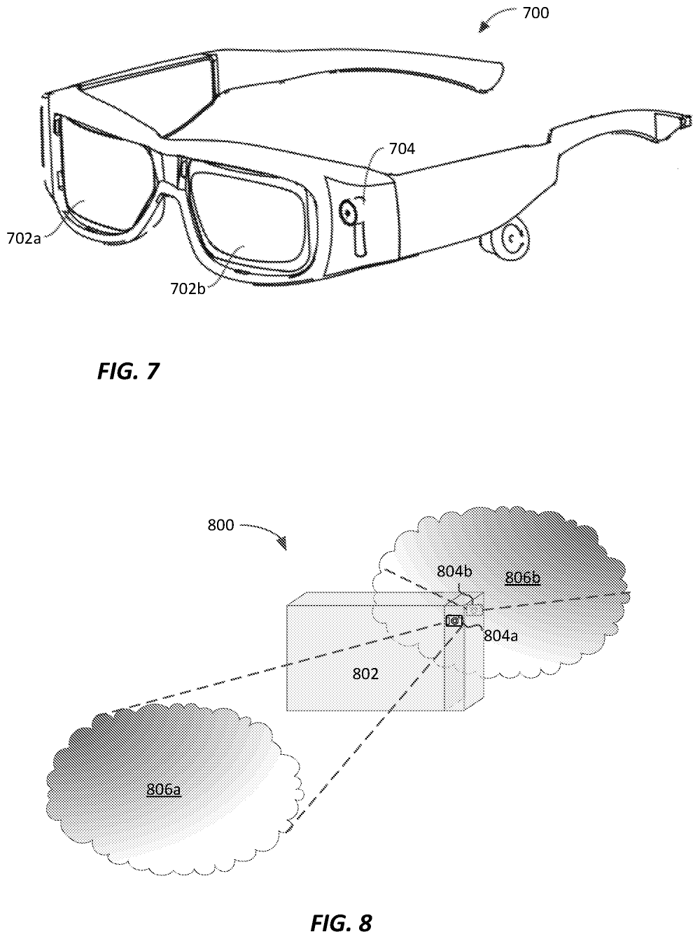

Embodiments of the present invention may be implemented with any desired display system. As an example, embodiments of the present invention may be implemented in a head-mounted display system such as system 700 of FIG. 7. Head-mounted display system 700 may include one or more displays 702a and 702b (e.g., right-eye and left-eye displays) and one or more sensors 704 for obtaining information about the ambient lighting environment. Displays 702a and 702b may be transparent or semi-transparent and the one or more sensors 704 may include one or more ambient light sensors, one or more cameras, and/or one or more other sensors.

As another example, embodiments of the present invention may be implemented in a display system such as system 800 of FIG. 8. Display system 800 of FIG. 8 may include a display 802, one or more forward-facing sensors 804a, and/or one or more rear-facing sensors 804b. In some embodiments, display 802 may be an opaque display and rear-facing sensors 804b may be omitted. In other embodiments, display 802 may be a transparent or semi-transparent display. In general, front-facing sensors 804a (when included) may be used in capturing information about the ambient lighting conditions in region 806a (e.g., the space in front of display 802) and how they vary spatially, while rear-facing sensors 804b (when included) may be used in capturing information about the ambient lighting conditions in region 806b (e.g., the space behind display 802). In certain embodiments, sensors 804a and/or 804b may be further configured for tracking the positions of one or more viewers of display 802 (as the perspective of the viewers can be considered in the disclosed techniques for ambient light adaptivity). Each of sensors 804a and 804b may include one or more ambient light sensors, one or more cameras, one or more rangefinders (e.g., for measuring a distance to a viewer), and/or one or more other sensors.

Example Computer System Implementation

Embodiments of the present invention may be implemented with one or more processors (optionally in combination with memory), a computer system, systems configured in electronic circuitry and components, an integrated circuit (IC) device such as a microcontroller, a field programmable gate array (FPGA), or another configurable or programmable logic device (PLD), a discrete time or digital signal processor (DSP), an application specific IC (ASIC), and/or apparatus that includes one or more of such systems, devices or components. The computer and/or IC may perform, control, or execute instructions relating to ambient-light adaptive display management processes, such as those described herein. The computer and/or IC may compute any of a variety of parameters or values that relate to ambient-light adaptive display management processes described herein. The image and video embodiments may be implemented in hardware, software, firmware, and various combinations thereof.

Certain implementations of the invention comprise computer processors which execute software instructions which cause the processors to perform a method of embodiments of the invention. For example, one or more processors in a display, an encoder, a set top box, a transcoder or the like may implement methods related to ambient-light adaptive display management processes as described above by executing software instructions in a program memory accessible to the processors. Embodiments of the invention may also be provided in the form of a program product. The program product may comprise any non-transitory medium which carries a set of computer-readable signals comprising instructions which, when executed by a data processor, cause the data processor to execute a method of embodiments of the invention. Program products according to embodiment of the invention may be in any of a wide variety of forms. The program product may comprise, for example, physical media such as magnetic data storage media including floppy diskettes, hard disk drives, optical data storage media including CD ROMs, DVDs, electronic data storage media including ROMs, flash RAM, or the like. The computer-readable signals on the program product may optionally be compressed or encrypted.

Where a component (e.g. a software module, processor, assembly, device, circuit, etc.) is referred to above, unless otherwise indicated, reference to that component (including a reference to a “means”) should be interpreted as including as equivalents of that component any component which performs the function of the described component (e.g., that is functionally equivalent), including components which are not structurally equivalent to the disclosed structure which performs the function in the illustrated example embodiments of the invention.

### EQUIVALENTS, EXTENSIONS, ALTERNATIVES AND MISCELLANEOUS

Example embodiments that relate to ambient-light adaptive display management processes are thus described. In the foregoing specification, embodiments of the present invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage, or attribute that is not expressly recited in a claim should limit the scope of such claim in any way. The specification and drawings are, accordingly, to be regarded in an illustrative rather than a restrictive sense.

Various aspects of the present invention may be appreciated from the following enumerated example embodiments (EEEs):

EEE 1. A method for adaptive display management with position-varying adaptivity to ambient light and/or non-display originating surface light using one or more processors, the method comprising:
receiving at least first and second sets of viewing environment parameters;
receiving an effective luminance range for a target display;
receiving an input image comprising pixel values;
generating a tone-mapped image by mapping, with the one or more processors, intensity values of the input image pixel values to intensity values in the tone-mapped image, wherein generating the tone-mapped image includes applying an original perceptually quantized (PQ) luminance mapping function and using the effective luminance range of the target display;
accessing at least first and second corrected PQ (PQ′) luminance mapping functions in dependence on at least one of the first and second sets of viewing environment parameters;
accessing at least first and second PQ-to-PQ′ mappings, wherein a first codeword in the original PQ luminance mapping function is mapped to a second codeword in the first corrected (PQ′) luminance mapping function and mapped to a third codeword in the second corrected (PQ′) luminance mapping function, according to the effective luminance range of the target display; and
generating an adjusted tone-mapped image by mapping intensity values in the tone-mapped image to intensity values in the adjusted tone-mapped image, wherein generating the adjusted tone-mapped image is dependent on utilizing the first PQ-to-PQ′ mapping for at least a first region of the tone-mapped image and utilizing the second PQ-to-PQ′ mapping for at least a second region of the tone-mapped image and wherein the first and second regions of the tone-mapped image are non-overlapping.

EEE 2. The method of EEE 1, wherein the first set of viewing environment parameters comprises a first ambient light luminance value associated with a first region of the target display, wherein the second set of viewing environment parameters comprises a second ambient light luminance value associated with a second region of the target display, and wherein the first region of the tone-mapped image corresponds to the first region of the target display and the second region of the tone-mapped image corresponds to the second region of the target display.

EEE 3. The method of EEE 1 or EEE 2, further comprising:
capturing, with a camera, at least one image; and
generating, with the one or more processors, the first and second sets of viewing environment parameters from the at least one image.

EEE 4. The method of any of EEEs 1-3, further comprising:
capturing, with a first camera, at least a first image of the ambient environment in front of the target display;
capturing, with a second camera, at least a second image of the ambient environment behind the target display; and
generating, with the one or more processors, the first and second sets of viewing environment parameters from the first image and the second image.

EEE 5. The method of any of EEEs 1-4, wherein accessing the at least first and second corrected (PQ′) luminance mapping functions is in further dependence on screen reflectivity properties and/or screen transmissivity properties of the target display.

EEE 6. The method of any of EEEs 1-5, wherein the original PQ luminance mapping function comprises a function computed according to the SMPTE ST 2084 specification.

EEE 7. The method of any of EEEs 1-6, wherein the effective luminance range for the target display comprises a minimum display luminance value (TMin) and a maximum display luminance value (TMax).

EEE 8. The method of any of EEEs 1-7, wherein the first and second PQ-to-PQ′ mappings preserve the relative position of the first codeword within the effective luminance range for the target display.

EEE 9. The method of EEE 8, wherein the first and second PQ-to-PQ′ mappings preserve the relative position of the first codeword within the effective luminance range for the target display by mapping, in the first PQ-to-PQ′ mapping, the first codeword to the second codeword using linear interpolation and mapping, in the second PQ-to-PQ′ mapping, the first codeword to the third codeword using linear interpolation.

EEE 10. A method for adaptive display management of a transparent display with a one or more processors, the method comprising:
receiving at least a first ambient light luminance value associated with a first region of an ambient environment, the first region being behind the transparent display and viewable by a user through the transparent display;
receiving at least a second ambient light luminance value associated with a second region of the ambient environment, the second region being behind the transparent display and viewable by the user through the transparent display, wherein the first and second regions of the ambient environment are non-overlapping;
receiving an input image comprising pixel values;
accessing a first luminance mapping function based at least on the first ambient light luminance value;
accessing a second luminance mapping function based at least on the second ambient light luminance value; and
generating an adjusted image based on the input image and the first and second luminance mapping functions, wherein generating the adjusted image is based on utilizing the first luminance mapping function for at least a first area of the adjusted image and utilizing the second luminance mapping function for at least a second area of the adjusted image, where the first and second areas of the adjusted image are non-overlapping.

EEE 11. The method of EEE 10, wherein the transparent display is configured to be worn by the user, the method further comprising, with an outward-facing sensor, obtaining the first and second ambient light luminance values.

EEE 12. The method of EEE 10 or EEE 11, wherein the transparent display is configured to be worn by the user, the method further comprising:
obtaining, with an outward-facing camera, an image of the ambient environment viewable by the user when wearing the transparent display; and
generating the first and second ambient light luminance values from the obtained image.

EEE 13. The method of any of EEEs 10-12, wherein the transparent display is part of a system including a forward-facing sensor and a backward-facing sensor, the method further comprising:
obtaining, with the backward-facing sensor, the first and second ambient light luminance values;
obtaining, with the forward-facing sensor, a third ambient light luminance value associated with a third region of the ambient environment, the third region being in front of the transparent display; and
obtaining, with the forward-facing sensor, a fourth ambient light luminance value associated with a fourth region of the ambient environment, the fourth region being in front of the transparent display.

EEE 14. The method of EEE 13, wherein accessing the first luminance mapping function is based at least on the first and third ambient light luminance values and wherein accessing the second luminance mapping function is based at least on the second and fourth ambient light luminance values.

EEE 15. The method of any of EEEs 10-14, wherein the transparent display comprises a first display portion having a first amount of transmittance to ambient light and a second display portion having a second amount of transmittance different from the first amount of transmittance, wherein accessing the first mapping function is further based at least on the first amount of transmittance, and wherein accessing the second mapping function is further based at least on the second amount of transmittance.

EEE 16. The method of EEE 15, wherein the transmittance of the transparent display varies spatially and temporally based on displayed content, the method further comprising determining, based on the received input image, the current spatially-distributed transmittance of the transparent display.

EEE 17. The method of claim 15 or EEE 16, further comprising displaying the first region of the adjusted image on the first display portion of the transparent display and displaying the second region of the adjusted image on the second display portion of the transparent display.

EEE 18. An apparatus comprising a processor and configured to perform the method recited in any of EEEs 1-17.

EEE 19. A non-transitory computer-readable storage medium having stored thereon computer-executable instruction for executing a method with one or more processors in accordance with any of EEEs 1-17.

1. A method for adaptive display management with position-varying adaptivity to ambient light and/or non-display originating surface light using one or more processors, the method comprising:
receiving an effective luminance range for a target display;
receiving first and second sets of viewing environment parameters, wherein the first set of viewing environment parameters comprises a first ambient light luminance value associated with a first region of the target display, wherein the second set of viewing environment parameters comprises a second ambient light luminance value associated with a second region of the target display;
receiving an input image comprising pixel values;
generating a tone-mapped image by mapping, with the one or more processors, intensity values of the input image pixel values to intensity values in the tone-mapped image, wherein generating the tone-mapped image includes applying an original perceptually quantized (PQ) luminance mapping function using the effective luminance range of the target display;
accessing first and second corrected PQ (PQ′) luminance mapping functions in dependence on the first and second sets of viewing environment parameters, respectively;
accessing first and second PQ-to-PQ′ mappings, wherein, in the first PQ-to-PQ′ mapping, a first codeword in the original PQ luminance mapping function is mapped to a second codeword in the first corrected (PQ′) luminance mapping function and, in the second PQ-to-PQ′ mapping, the first codeword in the original PQ luminance mapping function is mapped to a third codeword in the second corrected (PQ′) luminance mapping function, according to the effective luminance range of the target display; and
generating an adjusted tone-mapped image by mapping intensity values in the tone-mapped image to intensity values in the adjusted tone-mapped image, wherein generating the adjusted tone-mapped image is dependent on utilizing the first PQ-to-PQ′ mapping for a first region of the tone-mapped image corresponding to the first region of the target display and utilizing the second PQ-to-PQ′ mapping for a second region of the tone-mapped image corresponding to the second region of the target display and wherein the first and second regions of the tone-mapped image are non-overlapping.

2. The method of claim 1, wherein accessing the first and second corrected (PQ′) luminance mapping functions in dependence on the first and second sets of viewing environment parameters, respectively, comprises:
selecting the first corrected (PQ′) luminance mapping from a plurality of corrected (PQ′) luminance mapping functions by determining that the first corrected (PQ′) luminance mapping function is associated with a first level of ambient light and/or first level of non-display originating surface light that most closely matches, as compared to the other corrected (PQ′) luminance mapping functions in the plurality of corrected (PQ′) luminance mapping functions, the first set of viewing environment parameters; and
selecting the second corrected (PQ′) luminance mapping from the plurality of corrected (PQ′) luminance mapping functions by determining that the second corrected (PQ′) luminance mapping function is associated with a second level of ambient light and/or second level of non-display originating surface light that most closely matches, as compared to the other corrected (PQ′) luminance mapping functions in the plurality of corrected (PQ′) luminance mapping functions, the second set of viewing environment parameters.

3. The method of claim 1, further comprising:
capturing, with a camera, at least one image; and
generating, with the one or more processors, the first and second sets of viewing environment parameters from the at least one image.

4. The method of claim 1, further comprising:
capturing, with a first camera, at least a first image of the ambient environment in front of the target display;
capturing, with a second camera, at least a second image of the ambient environment behind the target display; and
generating, with the one or more processors, the first and second sets of viewing environment parameters from the first image and the second image.

5. The method of claim 1, wherein accessing the at least first and second corrected (PQ′) luminance mapping functions is in further dependence on screen reflectivity properties and/or screen transmissivity properties of the target display.

6. The method of claim 1, wherein the original PQ luminance mapping function comprises a function computed according to the SMPTE ST 2084 specification.

7. The method of claim 1, wherein the first and second PQ-to-PQ′ mappings preserve the relative position of the first codeword within the effective luminance range for the target display.

8. The method of claim 7, wherein the first and second PQ-to-PQ′ mappings preserve the relative position of the first codeword within the effective luminance range for the target display by mapping, in the first PQ-to-PQ′ mapping, the first codeword to the second codeword using linear interpolation and mapping, in the second PQ-to-PQ′ mapping, the first codeword to the third codeword using linear interpolation.

9. The method of claim 1, wherein the target display comprises a transparent display, wherein the first set of viewing environment parameters are associated with a first region of an ambient environment behind the transparent display and viewable by a user through the transparent display, and wherein the second set of viewing environment parameters are associated with a second region of the ambient environment behind the transparent display and viewable by the user through the transparent display.

10. The method of claim 9, wherein the transparent display is configured to be worn by the user, the method further comprising obtaining, with an outward-facing sensor, the first and second sets of viewing environment parameters.

11. The method of claim 9, wherein the transparent display comprises a first display portion having a first amount of transmittance to ambient light and a second display portion having a second amount of transmittance to ambient light, wherein the first and second amounts of transmittance are different, wherein accessing the first PQ-to-PQ′ mapping is further dependent on at least on the first amount of transmittance, and wherein accessing the second PQ-to-PQ′ mapping is further dependent on at least on the second amount of transmittance.

12. The method of claim 9, wherein the transmittance of the transparent display varies spatially and temporally depending on displayed content, the method further comprising determining, dependent on the input image, the current spatially-distributed transmittance of the transparent display.

13. An apparatus comprising a processor and configured to perform the method recited in claim 1.

14. A non-transitory computer-readable storage medium having stored thereon computer-executable instruction for executing with one or more processors, the method of claim 1.
